(19) United States
(12) Patent Application Publication
(10) Pub. No.: US 2015/0032612 A1
(43) Pub. Date: Jan. 29, 2015

(54) MOBILE DEBIT NOTE PAYMENT METHOD, AND A SYSTEM THEREFORE

(71) Applicant: Seamless Distributin AB, Stockholm (SE)

(72) Inventors: Mikael Signarsson, Upplands Vasby (SE); Bogdan Sacujiu, Stockholm/Spanga (SE)

(21) Appl. No.: 14/377,966

(22) PCT Filed: Jan. 29, 2013
(86) PCT No.: PCT/SE2013/000012

§ 371 Date: Aug. 11, 2014

Related U.S. Application Data
(60) Provisional application No. 61/597,990, filed on Feb. 13, 2012.

(30) Foreign Application Priority Data
Feb. 10, 2012 (SE) 1200088-1

(51) Int. Cl. G06Q 20/10; G06Q 20/40; G06Q 20/32

(52) U.S. Cl. CPC G06Q 20/102; G06Q 20/322; G06Q 20/3276; G06Q 20/40
USPC 705/40

(57) ABSTRACT

The invention relates to a method and a system adapted to the payment of a bill (14) by a cellular device (18) by reading a code (22) provided on the bill (14), and transmitting (24) the code (22) to a secure payment switch (26) for evaluation of its accuracy.

### TECHNICAL FIELD

The present invention pertains to a method and a system adapted to the payment of a bill by a cellular device by reading a code provided on said bill.

### BACKGROUND ART

When consumers pay a bill they typically pay it in three different ways such as through Internet payments most commonly available in developed markets, by queuing at a bank or biller's bill Payment Network, by an automatic standing payment through a bank.

No matter if you are living in a developed world or in an emerging market, most people recognize the pain and hassle of paying a bill. Customers waste time in queues, a hassle to enter relevant bill payment details such as amount of payment, biller account, reference number, and other particulars. Billers and customers do often not pay on time, there is delay in receiving cash from banks & bill payment processors, and heavy investments and costs to handle payment of bills.

It is a known fact that most bills issuing Software has built-in capabilities to create barcodes and various 2D barcodes.

Hence, the present invention intends to take advantages of the possibilities that barcodes provide to accomplish payment of bills in an innovative manner as described further below.

The international patent application WO 2011/107576 A1 discloses a payment method between a mobile terminal user/byer, and preferably a cashier/point of sale (POS) by the mobile terminal user sending an id to the POS. A transaction server settles the accounts between the buyer, and the POS through the byer entering a PIN code on his mobile terminal. Moreover, the POS can also be equipped with a mobile terminal, whereby a purchase is accomplished between two mobile terminals instead of a cashier device. Online shopping is also possible.

The WO 2011/107576 A1 document totally relies on purchases at a point of sale, and not to pay issued debit notes/invoices from deliverers of goods/services at a real time purchase, and thus not as debit notes commonly for trusted purchasers, which are paid in for instance a 30 days due date. Moreover, WO 2011/107576 A1 thus not describe the exchange of for instance quick response codes (QR) between buyer and seller.

Another patent application document US 2011/0307318 A1 describes a customer loyalty program which utilizes QR codes on for instance bills, and updates a customer loyalty account. This transaction is accomplished at a POS, and no settlement between bank accounts held by the customer and the POS merchandiser is accomplished.

Hence, it is evident that the mentioned left out/lacking particulars in the latter documents are conveyed by the attached set of independent claims. A customer loyalty program belongs to a different technical field than for payment of goods at for instance a POS as both documents convey. The present invention described below does not communicate with or through a POS site.

### SUMMARY OF THE INVENTION

One aim among others of the present invention is to provide a seamless secure (SEQR®) payment of bills/invoices/debit notes, and the like. With a SEQR® payment of bills any issuer of bills has the opportunity to increase the means of payment for his customers by adding a cost effective and more convenient way to pay bills/invoices/debit notes in accordance with the present invention. In order to issue bills that offer customers a manner to pay a bill securely and quick by simply reading/scanning/taking footage of a single 2D barcode, or other codes with the capability of storing lots of data, a 2D code can store up to 255 characters, which contains all the relevant bill payment information.

Moreover, the SEQR® bill payment process in accordance with the present invention, permits billers to issue bill payments with minimal investments.

It is appreciated that the present invention also can be utilized by a third party for instance at a post office, shop, bank, agent and the like, which have a 2D scanning cellular phone, where a customer who would like to pay a bill with a 2D tag can go in and pay through the agent. In this embodiment, the customer for instance pays the agent in cash or pays by any other known means such as a credit/debit card, whereby the agents account is debited buy SEQR or any other payment service provider (PSP).

To solve problems with current payment of bills, the present invention sets forth a method adapted to the payment of a bill by a cellular device by reading a code provided on the bill. The method of the present invention comprises the steps of:

the biller providing the bill with the code, the code including all the customer debit information that is conventionally provided by a biller, and the bill is transmitted to the customer;

the code being readable by the cellular device through attached cellular device software and hardware applications;

the customer reading the bill code on the bill by the applications in order to pay the bill;

the customer transmitting the code to a payment switch, which reads the code particulars;

the payment switch authorizes the customer as a utilizer of the cellular payment, and if that is the case, transmits a message to the cellular device to induce the bill payment;

the customer acknowledges the payment if the customer accepts it, and if the transaction of payment is to be accomplished, and enters at least a personal identity code by the cellular device to accept a payment to the payment switch; and

the payment switch settles the payment between the customer bank, and the billers bank, respectively.

In one embodiment of the present invention comprises that the code is a quick response code, or similar 2D code.

Furthermore, the present invention sets forth a system adapted to the payment of a bill by a cellular device by reading a code provided on the bill, characterized in that the system comprises:

a bill provided with the code, the code including at least a part of customer debit information that is provided by a biller, and the bill is transmitted to the customer;

a cellular device reading the code through attached cellular device software and hardware applications;

an application means provided in the cellular device reading the bill code on the bill in order to be able to pay the bill;

a transmitter in the cellular device sending the code to a payment switch, which reads the code particulars;

a payment switch which authorizes the customer as a utilizer of the cellular payment, and if that is the case, transmits a message to the cellular device to induce the bill payment;

an acknowledges means in the customers cellular device, which induces the payment if the customer accepts it, and if the transaction of payment is to be accomplished, the customer enters at least a personal identity code by the cellular device to accept a payment to the payment switch; and

the payment switch means settling the payment between the customer bank, and the billers bank, respectively.

In one embodiment of the present system invention the code is a quick response code, or similar 2D code.

### A BRIEF DESCRIPTION OF THE DRAWING

Henceforth, reference is had to the accompanying drawing throughout the present description for a better understanding of the present inventions embodiments, and given examples, wherein:

FIG. 1 schematically illustrates a system for secure payment of bills through a code, and a cellular device in accordance with the present invention.

### DETAILED DESCRIPTION OF PREFERRED EMBODIMENTS

The present invention regards a method and a system to a seamless secure (SEQR) payment of bills/invoices/debit notes, and the like as mentioned. With a SEQR payment of bills any issuer of bills has the opportunity to increase the means of payment for his customers by adding a cost effective and more convenient way to pay bills/invoices/debit notes in accordance with the present invention. In order to issue bills that offer customers a manner to pay a bill securely and quick by simply reading/scanning/taking footage of a single 2D barcode, or other codes with the capability of storing lots of data, a 2D code can store up to 255 characters, which contains all the relevant bill payment information.

Moreover, the SEQR bill payment process in accordance with the present invention, permits billers to issue bill payments with minimal investments.

As prerequisites a customer needs to have signed-up for a SEQR mobile payment service. Upon signing up he/she will get the option of having an account linked with SEQR that is either a debit or credit account or both. A user with a SEQR service can pay bills in a convenient manner.

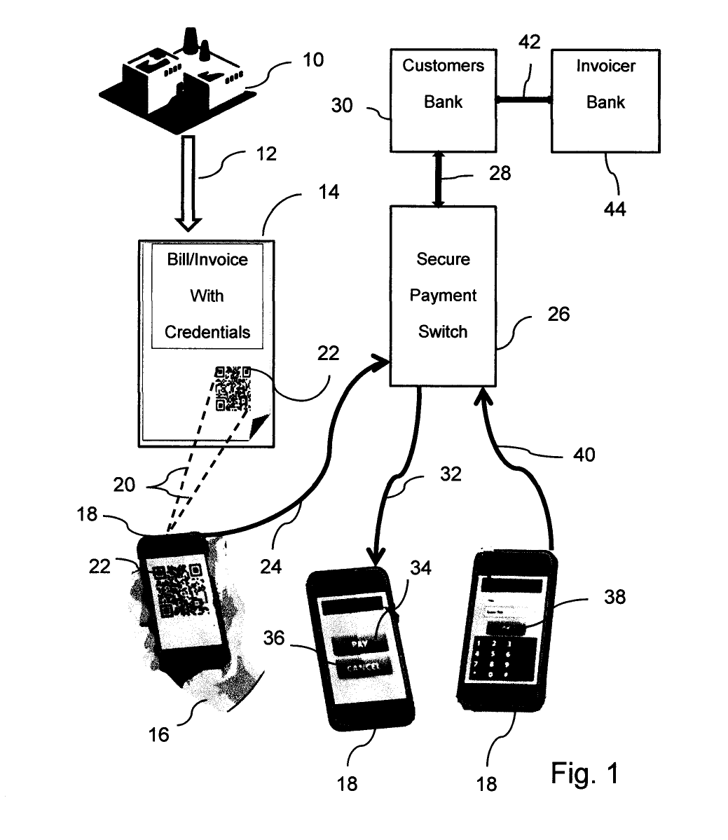

Hence, know referring to the attached FIG. 1, which depicts a system for payment of bills defined by the method described herein. FIG. 1 schematically illustrates how the method of payment of bills is accomplished. Thus, the FIG. 1 shows a bill issuer 10, which transmits 12 and issues a bill 14 to a customer for services or payment of goods and the like. The customer is in possession 16 of a cellular device 18 such as iPhone®, iPad®, cellular phone, personal digital assistant (PDA) or other devices communicating through cellular networks such as 2G, 2,5G, 3G, and 4G. In accordance with the present invention the customer reads/scans/photographs 20 received into the cellular device 18 by cellular devices software and hardware to read codes as for instance through a 2D barcode tagged on the bill 14 as for instance a quick response (QR) code. By pushing for instance a button or automatically by the application software on/in the cellular device 18, the device 18 transmits 24, the barcode information to a secure payment switch 26 provided by any suitable payment service provider (PSP). There, the information in the bar code 22 is checked for particulars such as bill issuer 10, bill recipient 16 (customer), account particulars, amount to be paid, if the account of the customer comprises the amount to be paid, optical character recognition (OCR) code, and other data needed to authorize the payment handled. Thereafter, the switch 26 authorizes the customer by a communication 32 of grant or denial of payment to the cellular device 18 menu, comprised in the software for this application, for the purpose to grant 34 or cancel 36 the payment.

When, for instance the payment is granted, the bill payer/customer agrees to pay the bill 14 to the bill issuer 10, shown as a factory for illustration purposes, by for instance pushing the ok button and/or entering a PIN code 36 on the device 18, and its menu. When this is performed, the device 18 transmits 40 the granting of payment to the payment switch 26, which settles the payment of the bill 14 through the communication 28, 42 with the customer bank 30 account, and the bill issuer bank 44 account, respectively. The settlement maybe incurred by several banks, not shown, depending on the specific country law regulating such payments. In Sweden for instance through the Central Bank (Riksbanken) governed by the Swedish Parliament (Riksdagen).

The payment described herein, follows for instance the following scheme, whereby, the customer 16, schematically shown by a hand in FIG. 1, receives a bill 14 from a biller 10, which contains a SEQR bill payment code 22. Hence the customer 16 scans/footage/reads the unique QR code provided on the bill, which can be a paper bill, or an e-mail bill, and transmits 24 the billers 10 identification to the secure payment switch 26. Upon this, the customer receives 32 a payment request 34, in and on the cellular device 18, asked to confirm payment details received by the switch 26, i.e. bill issuer identity, amount to be paid, and a reference number of the payment. Thereafter, the customer 16 confirms the amount to be paid by entering a personal identity (PIN) code. Similar to a current card payment, banks involved verify the credentials/particulars of the payment, by an existing back end/backbone network utilized for payment transactions.

In order to introduce the present invention payment, an agreement between the SEQR provider and Biller 10 has to be established so that SEQR bill Payments can be established.

A biller 10 can open a Bank account at a bank that is connected to the SEQR Payment Switch 26, to which the funds will be transmitted, or the billers existing bank. The funds can be transferred from a SEQR enabled bank account to any other bank account at agreed intervals, or directly to an appointed bank account at any other bank in the local country.

Hence, a simple customization to the design and layout of the bill 14, has to be accomplished to include a unique SEQR® Payment Code 22. This provides a convenient way to pay a bill 14 at anytime and anywhere, and a new inventive additional channel to pay a bill with increased access to payment, and a less delay in payments of invoices/bills/debit notes. There is no need to queue at bill payment locations for customers, and to enter payment details at bank or bill payment location. You just have to scan and validate what is written on the bill 14 through the 2D code. Whereby, funds are immediately available to the Biller. Furthermore in one embodiment the payment switch is able to notify for instance through an electronic message, the biller in almost real time that the bill 14 has been paid by the customer through a communication system integrated between billers and the switch 26. Hence, the biller will be notified of a customer payment long before for instance the bank notifies that the payment is on the biller bank account.

This provides mobile payment enabled bills without any major investment or integration of software and hardware. Also providing optional real-time notifications upon payment receipt (not required). Thus it is less expensive than through other existing bill payment channels. Most bills Issuing Software's have built-in capabilities to create barcodes such as 2D barcodes. One example of 2D barcodes utilized by SEQR® is a 2D QR barcode in accordance with the present invention. The SEQR® payment code ‘gathers’ mandatory and optional information contained in a bill 14, and a unique SEQR Biller ID. In one embodiment, the QR code is generated is based upon the following, i.e. information/data comprised in the code 22; SEQR® biller ID (mandatory), bill number (mandatory), total amount due (optional), bill period/description (optional), reference number (optional), bill date (optional), due date (optional). All the information/data to be comprised and generated in the code 22 is available on current bills except the unique SEQR® issued code.

A SEQR® customer scans/reads/footage 20 the SEQR® payment code 22 on the bill 14, and the SEQR® application stored in the cellular device 18 as software requests authentication of the merchant/biller identification. Thereafter, the SEQR server 26 validates the content in the biller's information in the code 22, and that the content/information/data code 22 is recognizable.

Moreover, the SEQR® customer 16 is presented to an authenticated biller/merchant identification (id), highlighting the recipient of funds that are most important, and required to do a validation of that the recipient biller 10 is the same as the issuer of the bill 14, that the amount of billing is the same as issued by the bill issuer 10, bill number is the same as on the bill 14 itself, bill 14 number is the same as on the bill code 22. When all items in the bill code tag 22 match the bill 14, the customer approves the payment by entering a valid PIN code, the payment is deducted/withdrawn from the account in question, and transferred to the billers 10 bank account, which provides a unique way to make a bill payment solution securely, without any expensive integrations or implementation efforts.

Payment settlement of bills can be transmitted to any known kind of account such as credit/debit card accounts, i.e. not necessarily a bank account.

It is appreciated that the present invention also can be utilized by a third party for instance at a post office, shop, bank, agent and the like, which have a 2D scanning cellular phone 18, where a customer who would like to pay a bill with a 2D tag can go in and pay through the agent cellular device 18. In this embodiment, the customer for instance pays the agent in cash or pays by any other known means such as a credit/debit card, whereby the agents account is debited buy SEQR® or any other payment service provider (PSP) switch 26.

The attached set of claims determines other possible embodiments of the present invention to a person skilled in the art of the present technical field.

1. A method adapted to the payment of a bill by a cellular device by reading a code provided on said bill, wherein said method comprises the steps of:
a biller providing said bill with said code, including, the customer debit information that is conventionally provided by a biller, and the bill is transmitted to said customer;
said code being readable by said cellular device through attached cellular device software and hardware applications;
said customer reading said bill code on said bill by said applications in order to pay said bill;
said customer transmitting said code to a payment switch, which records the code particulars;
said payment switch authorizes the customer as a utilizer of the cellular payment, and if that is the case, transmits a message to the cellular device to induce said bill payment;
said customer acknowledges the payment if said customer accepts it, and if the transaction of payment is to be accomplished, and enters at least a personal identity code by the cellular device to accept a payment to said payment switch;
said payment switch settling the payment between the customer bank, and said billers bank, respectively.

2. A method according to claim 1, wherein said code is a quick response Code, or similar 2D code.

3. A system adapted to the payment of a bill by a cellular device by reading a code provided on said bill, wherein said system comprises:
a bill provided with said code, said code including at least a part of customer debit information that is provided by a biller, and the bill code is transmitted to said customer;
a cellular device reading the code through attached cellular device software and hardware applications;
an application means provided in said cellular device reading said bill code on said bill in order to be able to pay said bill;
a transmitter in said cellular device sending said code to a payment switch, which reads the code particulars;
a payment switch which authorizes the customer as a utilizer of the cellular payment, and if that is the case, transmits a message to the cellular device to induce said bill payment;
an acknowledges means in the customers cellular device, which induces the payment if the customer accepts it, and if the transaction of payment is to be accomplished, the customer enters at least a personal identity code by the cellular device to accept a payment to said payment switch; and
said payment switch means settling the payment between the customer bank, and said billers bank, respectively.

4. A system according to claim 3, wherein said code is a quick response code, or similar 2D code.
